(19) United States
(12) Patent Application Publication
(10) Pub. No.: US 2005/0193192 A1
(43) Pub. Date: Sep. 1, 2005

(54) Electronic certificate validity check system and its method

(76) Inventors: Hisao Sakazaki, Fujisawa (JP); Seiichi Susaki, Yokohama (JP); Mitsuhiro Oikawa, Fujisawa (JP); Yutaka Tagawa, Yokohama (JP)

Correspondence Address: MCDERMOTT, WILL & EMERY, 600 13th Street, N.W., Washington, DC, 20005-3096, US

(21) Appl. No.: 10/847,647

(22) Filed: May 18, 2004

(30) Foreign Application Priority Data
Mar. 1, 2004 (JP) 2004-055648

(51) Int. Cl. H04L 9/00

(52) U.S. Cl. 713/156

(57) ABSTRACT

The signer obtains the validity check information on the electronic certificate from the certification authority when it puts the digital signature on data and delivers the signed data, electronic certificate, and validity check information to the verifier. At this time, the certification authority creates validity check information on the electronic certificate in response to a validity check request from the signer and sends it to the signer. The term of validity of the validity check information is defined as necessary. The verifier verifies the signature and, using the validity check information sent from the signer, checks the validity of the electronic certificate.

### INCORPORATION BY REFERENCE

This application claims priority based on a Japanese patent application No. 2004-055648 filed on Mar. 1, 2004, the entire contents of which are incorporated herein by reference.

### BACKGROUND OF THE INVENTION

The present invention relates to an electronic certificate validity check method.

In electronic commerce and so on in the network society, the validity of an electronic certificate is checked when a digital signature (hereinafter also simply called a signature) on an electronic document is verified, when access is controlled using an electronic certificate (hereinafter called a public key certificate or also simply called a certificate) at the time user logs into a server, or when home information appliances authenticate to each other using an electronic certificate.

According to the conventional technology for checking the validity of an electronic certificate, an electronic certificate verifier obtains validity check information and checks its validity (Refer to, for example, “Government Public Key Infrastructure (GPKI) Government Public Key Infrastructure Interoperability Specifications” Administrative Management Bureau of Ministry of Public Management, Home Affairs, Posts and Telecommunications, Feb. 28, 2003, pp. 9-14.)

### SUMMARY OF THE INVENTION

To verify a digital signature, it is necessary to check the validity of the electronic certificate to check that the signer of the digital signature is authentic. In such a case, the electronic certificate verifier must conventionally obtain validity check information on the electronic certificate. This load is heavy and there is a requirement for reducing this load.

The signer of an electronic certificate also has a desire to get an electronic certificate, which is costly and cumbersome, at a lower charge.

A third-party organization that issues electronic certificates also has a desire to lower the charge at electronic certificate issuance time and to increase the amount of electronic certificate issuance.

In view of the foregoing, the present invention provides a method and a system for checking the validity of an electronic certificate by allowing a signature device to present the validity check information on an electronic certificate of a signer to a verification device to check the validity of the electronic certificate.

More specifically, when verifying a digital signature, the signature device presents validity check information on the electronic certificate of the signer to the verification device in order to reduce the load on the verification device when the validity of the electronic certificate, required for checking the validity of the signer of the digital signature, is checked.

More specifically, the present invention provides an electronic certificate validity check method for use in a system comprising a signature device that requests to provide a service, a verification device that provides a requested service, and a certification authority device, wherein the signature device requests the certification authority device to send validity check information on an electronic certificate required for verifying a digital signature when the signature device puts the digital signature on an electronic document that requires the service, the certification authority device sends the requested validity check information to the signature device, the signature device creates signed data which is the electronic document to which the digital signature is attached, the validity of the digital signature being checked by the received validity check information and sends the signed data, the electronic certificate, and the validity check information to the verification device, and the verification device verifies the digital signature and checks the validity of the electronic certificate using the signed data, the electronic certificate, and the validity check information received from the signature device.

The electronic certificate validity check method according to the present invention may be configured in such a way that the signature device requests the verification device to provide a service, the verification device requests the signature device to provide the validity check information in response to the request to provide a service, and the signature device requests the certification authority device to provide the validity check information in response to the request to provide the validity check information.

The electronic certificate validity check method according to the present invention may be configured in such a way that the certification authority device sets a term of validity for the validity check information and, when a check is made for the validity of the electronic certificate, the verification device checks if the validity check information is within the term of validity that is set.

The electronic certificate validity check method according to the present invention may be configured in such a way that the certification authority device counts a number of times the signature device requests validity check information on the electronic certificate and performs charging processing for the signature device according to the number of times that is counted.

Thus, according to the present invention, the verification device can verify a signature and check the validity of a certificate using information delivered from the signature device. The term of validity of validity check information itself, if defined, could prevent the secondary use of the validity check information itself. In addition, because the signature device requests the certification authority device to send validity check information each time the signature device uses an electronic certificate, the certification authority device can identify the number of times the signature device uses the certificate and therefore collect the usage charge according to the number of times the certificate is used.

According to the present invention, because the verifier can verify the signature and check the validity of the certificate using information from the signer, the verifier's load is reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the network configuration in one embodiment.

FIG. 2 is a diagram showing an example of the configuration of a signature device, a verification device, and a certification authority device shown in FIG. 1.

FIG. 3 is a diagram showing an example of the hardware configuration of the signature device, verification device, and certification authority device shown in FIG. 1.

FIG. 4 is a diagram showing the configuration of validity check information in one embodiment.

FIG. 5 is a workflow diagram showing the overview of one embodiment.

FIG. 6 is a workflow diagram (1) showing the processing of the signature device in one embodiment.

FIG. 7 is a workflow diagram (2) showing the processing of the signature device in one embodiment.

FIG. 8 is a workflow diagram showing the processing of the verification device in one embodiment.

FIG. 9 is a workflow diagram showing the processing of the certification authority device in one embodiment.

FIG. 10 is a general diagram showing the overview of one embodiment.

### DETAILED DESCRIPTION OF THE EMBODIMENTS

One embodiment of the present invention will be described below with reference to the drawings. It should be noted that the present invention is not limited by this embodiment.

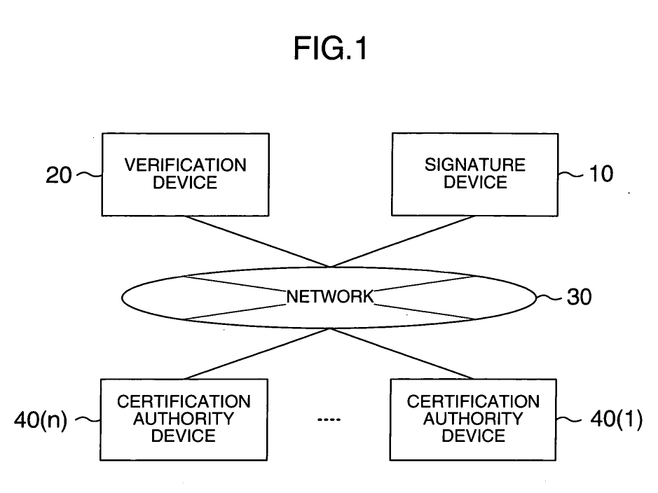

FIG. 1 is a network configuration diagram of a system to which one embodiment of the present invention is applied. As shown in FIG. 1, the system in this embodiment comprises a signature device 10, a verification device 20, and certification authority devices 40(1)-40(n), all of which are interconnected via a communication network (hereinafter called a network) 30 such as the Internet.

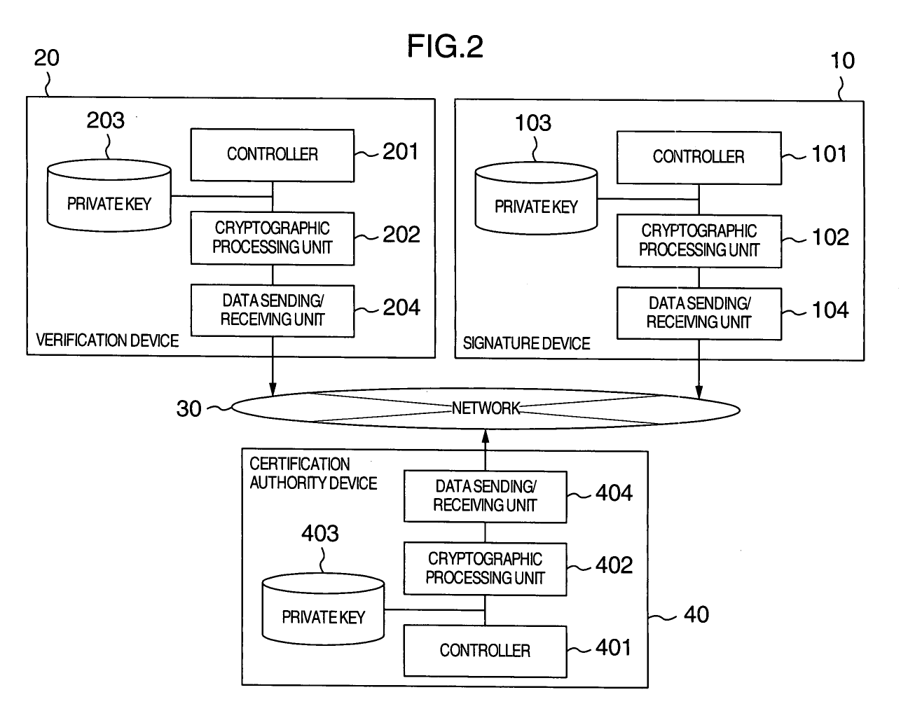

The signature device 10 obtains validity check information on the electronic certificate of a signer from the certification authority devices 40(1)-40(n) and delivers the information, as well as signed data and the electronic certificate, to the verification device 20 to allow the verification device 20 to verify the sign and to check the validity of the certificate. As shown in FIG. 2, the signature device 10 comprises a cryptographic processing unit 102 that puts a signature and so forth on an electronic document; a data sending/receiving unit 104 that sends and receives information such as signed data, an electronic certificate, validity check information, and a validity check request; a private key 103 that is private information on a signer; and a controller 101 that controls those components.

The verification device 20 presents information necessary for the signature device 10 to prepare certificate validity check information and verifies a signature and checks the validity of a certificate using signed data, an electronic certificate, and certificate validity check information delivered from the signature device 10. After checking the validity, the verification device 20 provides a service requested by the signature device 10. As shown in FIG. 2, the verification device 20 comprises a cryptographic processing unit 202 that verifies a signature; a data sending/receiving unit 204 that sends and receives information such as signed data, an electronic certificate, and validity check information; a private key 203 that is private information on a verifier; and a controller 201 that controls those components.

The certification authority device 40 creates validity check information on an electronic certificate in response to a validity check request from the signature device 10 and sends the information to the signature device 10. In addition, the certification authority device 40 defines the term of validity of the validity check information as necessary. The certification authority device 40 also collects charges for certificate validity check information requested by the signature device 10 as necessary. As shown in FIG. 2, the certification authority device 40 comprises a cryptographic processing unit 402 that verifies a signature or puts a signature on data such as validity check information; a data sending/receiving unit 404 that sends and receives information such as signed data, an electronic certificate, validity check information, and a validity check request; a private key 403 that is private information on the certification authority; and a controller 401 that controls those components.

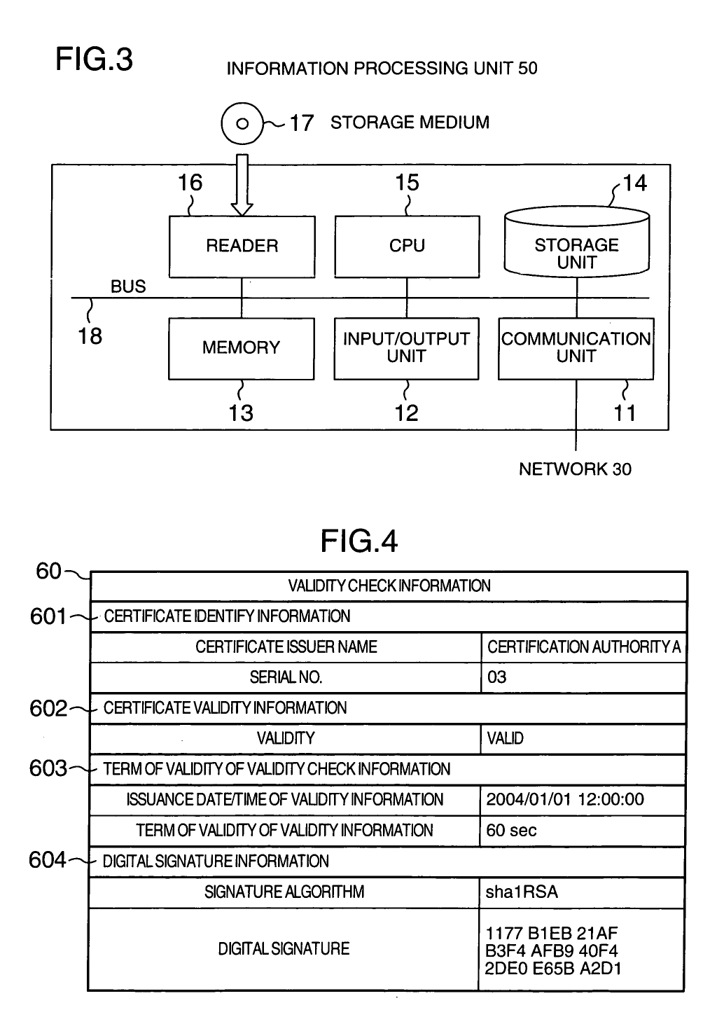

The signature device 10, verification device 20, and certification authority device 40 each can be configured on an information processing unit 50, as shown in FIG. 3, that comprises a communication unit 11, an input/output unit 12, a primary storage unit (hereinafter called a memory) 13 that uses a semiconductor, a secondary storage unit (hereinafter called a storage unit) 14 such as a hard disk, a CPU 15, and a reader 16 of a storage medium 17, all of which are connected by an internal communication line (hereinafter called a bus) 18 such as a bus.

The above described cryptographic processing units 102, 202, and 402, the data sending/receiving units 104, 204, and 404, and the controllers 101, 201, and 401 are each implemented on the corresponding device when the CPU 15 executes the programs stored in the memory 13 or the storage unit 14 of the device. Those programs can also be stored in advance in the storage unit 14 or can be installed in the information processing unit 50 via a removable storage medium 17 or a communication medium (network 30 or a carrier wave on the network 30) as necessary.

The overview of the system in this embodiment will be described below with reference to the drawings.

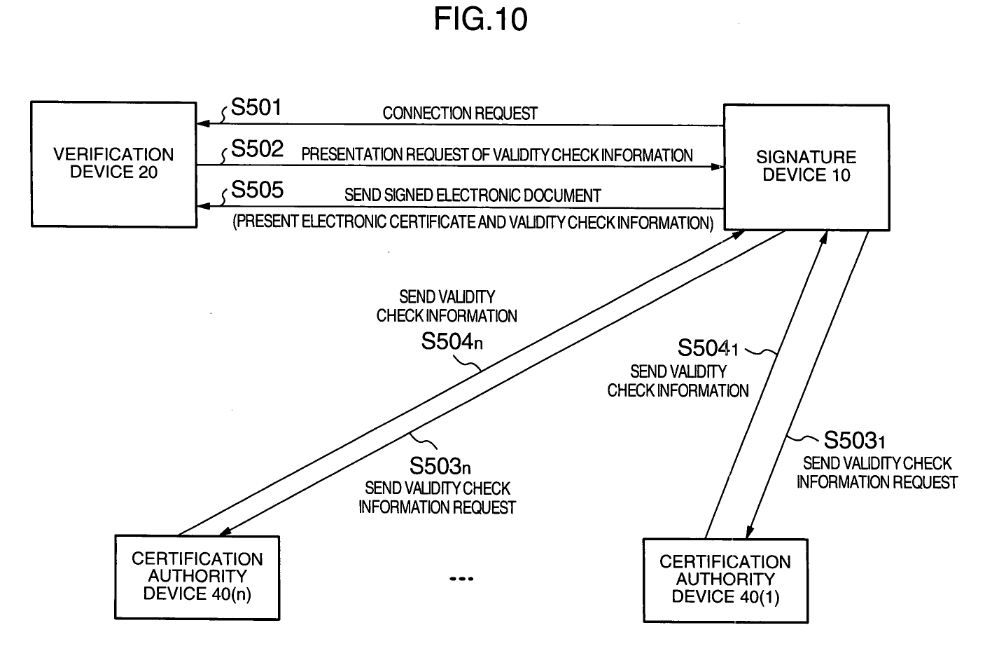

As shown in FIG. 10, the signature device 10 sends a connection request to use the service of the verification device 20 (described as step 501 or S501. The same notation will be used in the description below). The verification device 20 presents information, necessary for the signature device 10 to prepare certificate validity check information, such as the electronic certificate of a verifier and requests the signature device 10 to present validity check information (S502).

The signature device 10 requests the certification authority devices 40(1)-40(n), which are on a certification path used to verify the verification device 20, to present validity check information (S503₁₋ₙ).

The certification authority devices 40(1)-40(n) create validity check information on the electronic certificate and send the information to the signature device 10 (S504₁₋ₙ).

The signature device 10 sends the validity check information, which are obtained from the certification authority devices 40(1)-40(n), as well as the signed data and the electronic certificate to the verification device 20 (S505).

The verification device 20 verifies the digital signature of the signed data, sent from the signature device 10, checks the validity of the electronic certificate using the validity check information, and provides the service as necessary.

The processing flow of the system in this embodiment will be described with reference to FIG. 5.

It is assumed that the signature device 10 and the verification device 20 have not only their own electronic certificates but also all certificates on the certification path to their own root certificates.

The signature device 10 sends a connection request to the verification device 20 to use the service of the verification device 20 (S001).

The verification device 20 presents an electronic certificate, necessary for the signature device 10 to prepare certificate validity check information, and prompts it to present validity check information (S002).

The electronic certificate sent by the verification device 20 includes not only the electronic certificate of the verification device 20 but also all certificates on the certification path to its root certificate. Therefore, the signature device 10 can identify the domain to which the verification device 20 belongs.

The signature device 10 sends its electronic certificate and so on to the certification authority device (1) to request the certification authority device 40(1) to present validity check information on its electronic certificate (S003). At this time, it is assumed that the certification authority device 40(1) is under contract with the signature device 10 that validity check information is available for a charge.

The certification authority device 40(1) counts the number of requests for each signature device 10 for use in charging (S004). The certification authority device 40(1) sends a bill for the usage charge for a specific period to the signature device 10 asynchronously to the processing shown in FIG. 5 and prompts the signer to pay the charge through a bank transfer, an account transfer, a budget account, and a credit card.

The certification authority device 40(1) creates validity check information on the electronic certificate and sends it to the signature device 10 (S005). At this time, the certificate of the certification authority device 40(1) need not be sent because the signature device 10 already has that certificate.

Similarly, the signature device 10 requests a superior certification authority device 40(n) to present validity check information on the electronic certificate of the subordinate certification authority device 40(1) (S006).

The certification authority device 40(n) creates validity check information on the electronic certificate and sends it to the signature device 10. Charging processing is performed for the information sent from the certification authority device 40(1) that issues the electronic certificate of the signature device 10 under the contract described above. However, it is assumed that, for a presentation request of validity check information sent from the signature device 10 to a superior certification authority device 40(n), charging processing is not performed under the contract between the subordinate certification authority device 40(1) and the superior certification authority device 40(n) (S007).

The signature device 10, which now has the validity check information necessary for the verification device 20 to perform verification, puts a digital signature on the electronic document (an electronic document having a digital signature is called signed data), and sends the signed data and the electronic certificate, as well as the prepared validity check information, to the verification device 20 (S008). Note that the electronic certificate includes not only the electronic certificate of the signature device 10 itself but also all certificates of the certification path to the root certificate of itself. This enables the verification device 20 to identify the domain to which the signature device 10 belongs and, therefore, to easily find the certification path even if they belong to different domains.

The verification device 20 verifies the signature sent from the signature device 10 (S009) and checks the validity of the electronic certificates using the received validity check information (S010).

After verifying the signature and checking the validity of the certificate, the verification device 20 provides the signature device 10 with the service as necessary.

As described above, this embodiment allows the verification device to verify a signature and to make the validity check of a certificate using information from the signature device, thus reducing the load.

Because the certification authority device can charge for validity check information when it is provided, the total of the received charges will increase even if the charge required at electronic certificate issuance time is kept low.

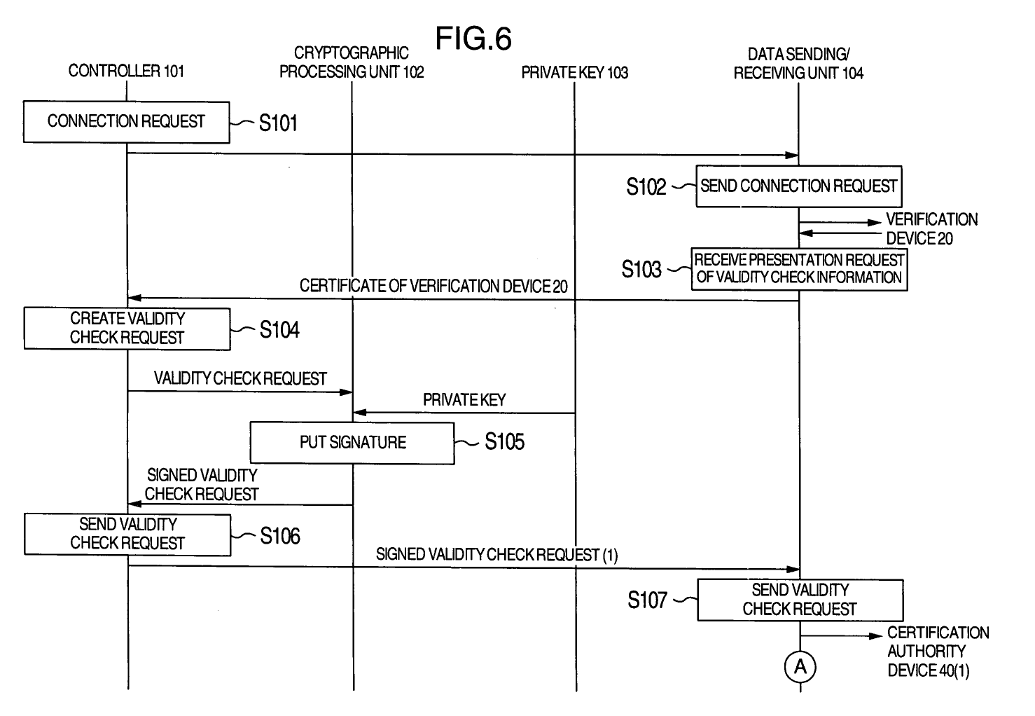

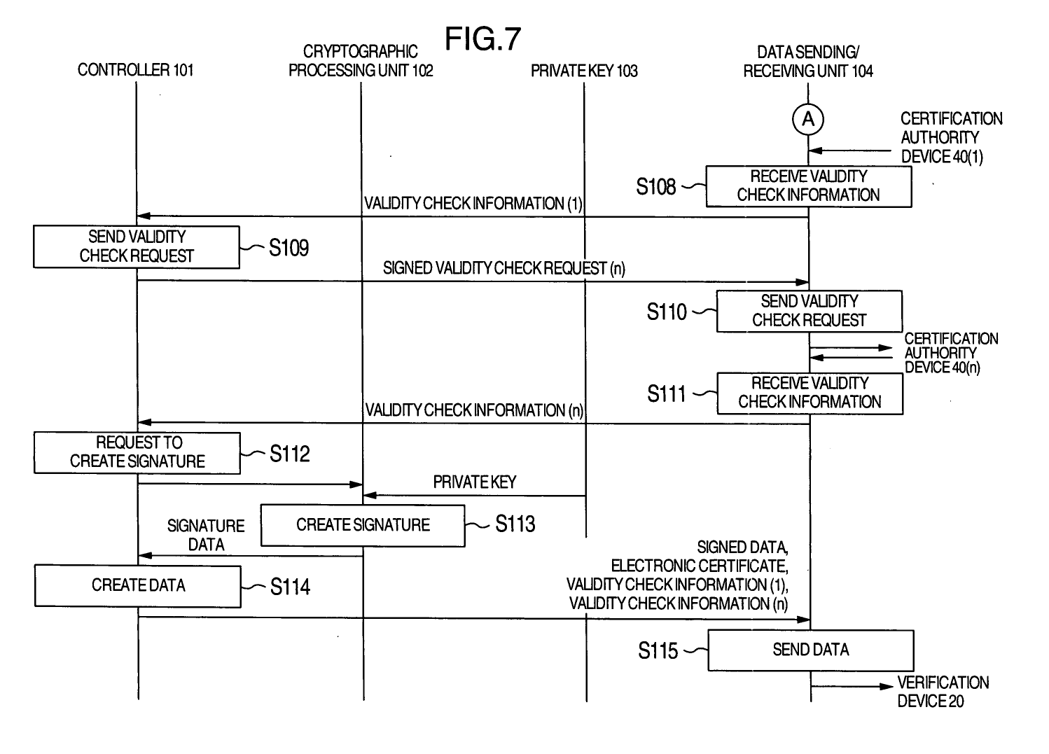

The following describes the processing flow of the signature device 10 in detail with reference to FIGS. 6 and 7.

The controller 101 sends a connection request to the verification device 20 via the data sending/receiving unit 104 to use the service of the verification device 20 (S101, 102).

The data sending/receiving unit 104 receives information, necessary for the signature device 10 to prepare certificate validity check information such as the electronic certificate of the verification device 20 (S103), from the verification device 20 and passes the received information to the controller 101.

The electronic certificate sent from the verification device 20 includes not only the electronic certificate of the verification device itself but also all certificates of the certification path to the root certificate of itself. This enables the signature device 10 to identify the domain to which the verification device 20 belongs and, therefore, to easily find the certification path even if they belong to different domains.

Based on the information on the domain to which the controller 101 belongs and the information on the domain to which the verification device 20 belongs, the controller 101 can identify all certification authority devices 40(1)-40(n) on the certification path from the signature device 10 to the root certification authority of the domain to which the verification device 20 belongs.

The controller 101 creates a validity check request to be sent to the certification authority devices 40(1)-40(n) (S104).

The cryptographic processing unit 102 puts a digital signature on the validity check request (S105).

The controller 101 sends the validity check request (1) to the certification authority device 40(1) via the data sending/receiving unit 104 (S106, S107).

The data sending/receiving unit 104 receives the validity check information (1) from the certification authority device 40(1) (S108) and passes it to the controller 101.

Similarly, the controller 101 sends the validity check request (n) to the certification authority device 40(n) via the data sending/receiving unit 104 (S109, 110).

The data sending/receiving unit 104 receives the validity check information (n) from the certification authority device 40(n) (S111) and passes it to the controller 101.

The validity check information like this is collected until the information, required for verification device 20 to check the validity of the electronic certificate, is collected.

The controller 101 creates an electronic document to be sent to the verification device 20 and requests the cryptographic processing unit 102 to create a digital signature to be put on the electronic document (S112), and the cryptographic processing unit 102 puts the signature on the electronic document (S113).

The controller 101 creates data (S114), in which the signed data, electronic certificate, and validity check information (1)—validity check information (n) are included, and sends the data to the verification device 20 via the data sending/receiving unit 104 (S115).

The electronic certificate includes not only the electronic certificate of the signature device itself but also all certificates on the certification path to its root certificate. This enables the verification device 20 to identify the domain to which the signature device 10 belongs and, therefore, to easily find the certification path even if they belong to different domains.

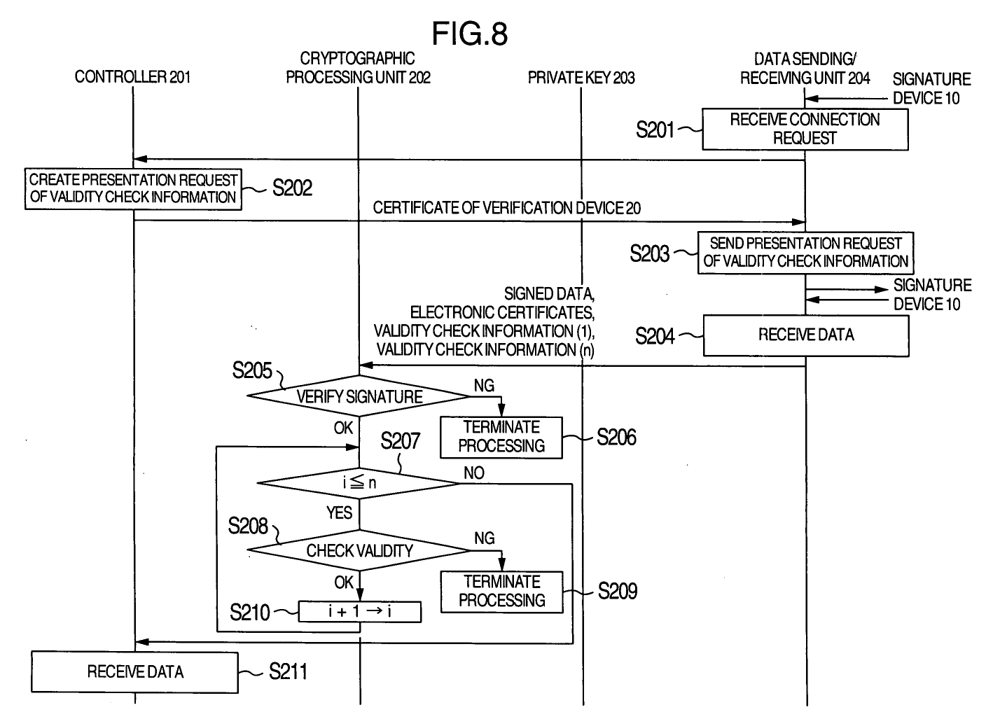

FIG. 8 is a flowchart showing the processing of the verification device 20 in detail.

The data sending/receiving unit 204 receives a connection request from the signature device 10 (S201) and passes it to the controller 201.

The controller 201 creates information necessary for the signature device 10 to prepare certificate validity check information including the electronic certificate of itself (S202) and sends the information to the signature device 10 via the data sending/receiving unit 204 (S203).

The information required for the signature device 10 to prepare certificate validity check information is data including not only the electronic certificate of the verification device itself but also all certificates on the certification path to the root certificate. This enables the signature device 10 to identify the domain to which the verification device 20 belongs. Therefore, the signature device 10 can easily find the certification path even if they belong to different domains.

The data sending/receiving unit 204 receives data, in which the signed data, electronic certificates, and validity check information (1)—validity check information (n) are included, from the signature device 10 (S204).

The electronic certificates sent from the signature device 10 include not only the electronic certificate of the signature device itself but also all certificates on the certification path to its root path. This enables the verification device 20 to identify the domain to which the signature device 10 belongs and, therefore, to easily find the certification path even if they belong to different domains.

The cryptographic processing unit 202 verifies the signature of the signed data using the public key of the signature device 10 described on the certificate of the signature device 10 (S205). If the signature passes the verification (OK in S205), the cryptographic processing unit 202 checks the validity of all electronic certificates using the validity check information (1)—validity check information (n) and, in addition, checks if all validity check information (1)—validity check information (n) are within the term of validity. A very short period of time (for example, on order of seconds), if set for the term of validity of the validity check information, could prevent the secondary use of the validity check information itself (S207, S208, S210). The validity check information includes the digital signature of each certification authority device 40 and, using a public key described in the certificate of each certification authority device 40, a check is made to see if the validity check information is not modified.

If the signature does not pass the signature verification (NG in S205) or if at least one of the electronic certificates is found invalid as a result of validity checking (NG in S208), the verification device 20 notifies the signature device 10 about the condition and terminates processing (S206, S209).

If all electronic certificates are valid, the verification device 20 receives data (S211) and provides the signer with the service as necessary.

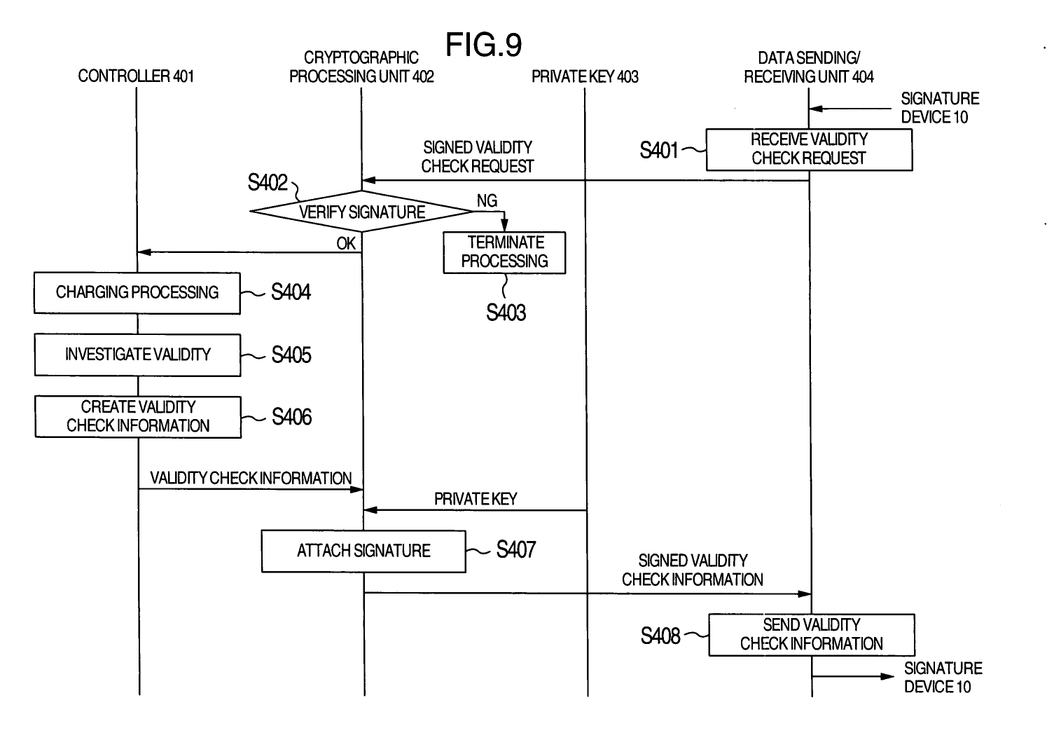

The processing of the certification authority device 40 will be described in detail with reference to FIG. 9.

The data sending/receiving unit 404 receives a validity check request from the signature device 10 (S401).

The cryptographic processing unit 402 verifies the signature of the validity check request (S402) and, if the signature passes the verification, collects the usage charge as necessary (S404).

The controller 401 checks the validity of the electronic certificate (S405) and creates validity check information based on the investigation result (S406). The controller 401 defines the term of validity of validity check information itself and describes it in the validity check information as necessary.

The cryptographic processing unit 402 adds the signature to the validity check information (S407) and sends the validity check information to the signature device 10 via the data sending/receiving unit 404 (S408).

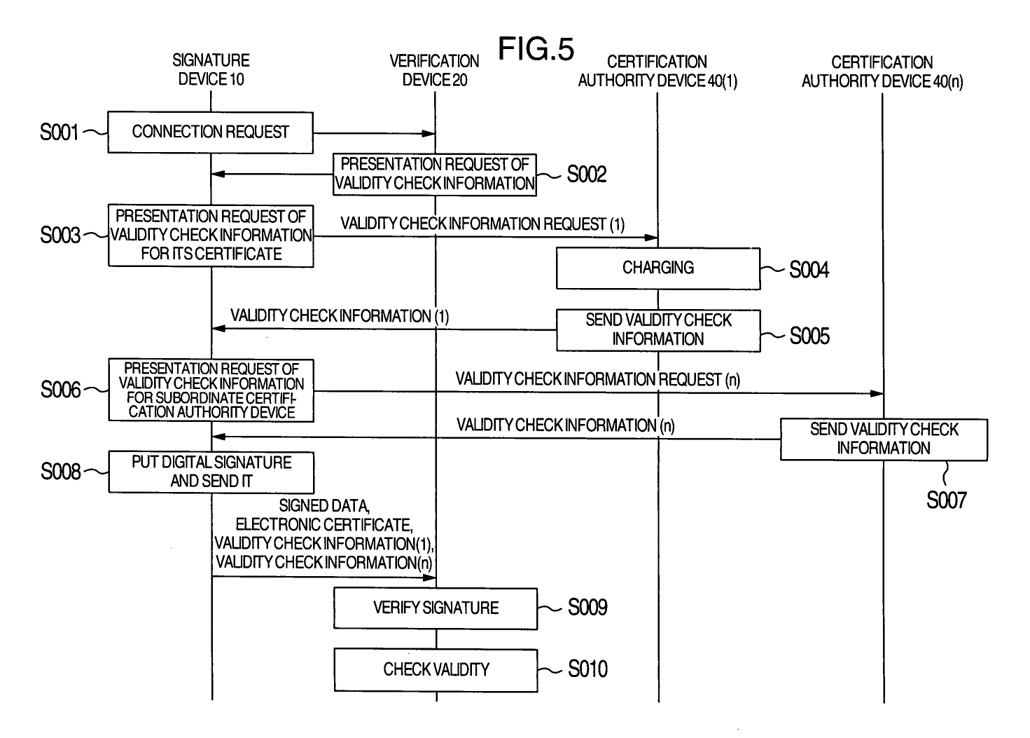

FIG. 4 is a diagram showing the structure of the validity check information.

Validity check information 60 comprises certificate identify information 601 that uniquely identifies the certificate, certificate validity information 602 that indicates the validity of the certificate, a term of validity 603 of validity check information that indicates the validity of validity check information, and digital signature information 604 that indicates that the validity check information is not modified. The certificate identify information 601, composed of a certificate issuer and a serial number, uniquely identifies the certificate. The certificate validity information 602 indicates the validity of the certificate. The term of validity 603 of validity check information, which is optional, indicates the validity information issuance date/time and the term of validity that indicate the term of validity of the validity check information. Note that a very short time is set for the term of validity 603 of validity check information to prevent the secondary use of the validity check information 60. The digital signature information 604 indicates a digital signature and digital signature algorithm information in use to indicate that the validity check information is not modified. The verification device 20 uses those types of information to certify the validity of the certificate and the validity and legality of the validity check information.

As described above, this embodiment allows the verification device to verify a signature and to check the validity of a certificate using information from the signature device, thus reducing the load.

Because the certification authority device can charge for validity check information when it is provided, the total of the received charges will increase even if the charge required at electronic certificate issuance time is kept low.

The present invention is not limited to this embodiment but various modifications are possible within the scope of the spirit.

For example, the signed data, electronic certificates, and validity check information (1)—validity check information (n) are sent to the verification device 20 at a time in S008 in FIG. 5, the signed data and electronic certificates may be sent to the verifier in advance and only the validity check information (1)—validity check information (n) may be sent in S008.

Although the signature device 10 once sends a connection request to the verification device 20 and receives a validity check information presentation request from the verification device 20 in S001 and S002 in FIG. 5, those steps may be omitted if the singer has obtained, in advance, the information required for preparing certificate validity check information such as the electronic certificate of the verifier.

Although the signature device 10 puts a signature on an electronic document and sends it to the verification device 20 in S008 in FIG. 5, the signature device 10 may also put a signature not only in document format data, such as an electronic contract and an electronic application form, but also in data, such as login data that is entered when a client logs into a server that operates electronic commerce business, for controlling access. In addition, the signature device 10 can be used for putting a signature on an electronic contract when commercial products are traded. The signature device 10 can also be used not only between a client and a server but also for apparatus authentication among home information appliances.

Although only the certification authority device 40(1) performs charging processing under contract between the signature device 10 and the certification authority device 40(1) in S004 in FIG. 5, all or part of certification authority devices 40(1)-40(n) may perform charging processing by making a contract between the signature device 10 and certification authority devices 40(1)-40(n).

It should be further understood by those skilled in the art that although the foregoing description has been made on embodiments of the invention, the invention is not limited thereto and various changes and modifications may be made without departing from the spirit of the invention and the scope of the appended claims.

1. An electronic certificate validity check method for use in a system comprising a signature device that requests to provide a service, a verification device that provides a requested service, and a certification authority device, comprising the steps of:
requesting, by the signature device; the certification authority device to send validity check information on an electronic certificate required for verifying a digital signature when the signature device puts the digital signature on an electronic document that requires the service;
sending, by the certification authority device, the requested validity check information to the signature device;
creating, by the signature device, signed data which is the electronic document to which the digital signature is attached, the validity of the digital signature being checked by the received validity check information;
sending, by the signature device, the signed data, the electronic certificate, and the validity check information to the verification device; and
verifying, by the verification device, the digital signature and checks the validity of the electronic certificate using the signed data, the electronic certificate, and the validity check information received from the signature device.

2. The electronic certificate validity check method according to claim 1, further comprising the steps of:
requesting, by the signature device, the verification device to provide a service;
requesting, by the verification device, the signature device to provide the validity check information in response to the request to provide a service; and
requesting, by the signature device, the certification authority device to provide the validity check information in response to the request to provide the validity check information.

3. The electronic certificate validity check method according to claim 1, further comprising the steps of:
setting, by the certification authority device, a term of validity for the validity check information; and
checking, when a check is made for the validity of the electronic certificate, by the verification device, if the validity check information is within the term of validity that is set.

4. The electronic certificate validity check method according to claim 1, further comprising the steps of:
counting, by the certification authority device, a number of times the signature device requests validity check information on the electronic certificate; and
performing, by the certification authority device, charging processing for the signature device according to the number of times that is counted.

5. A verification device that provides a service, which is requested by a signature device, after verifying a digital signature attached by the signature device, comprising:
unit that requests the signature device to provide validity check information in response to the request to provide a service; and
unit that checks the validity of an electronic certificate sent from the signature device, using the validity check information sent from the signature device in response to the request to provide the validity check information.

6. The verification device according to claim 5, further comprising unit that provides an electronic certificate thereof when the verification device requests the signature device to provide the validity check information.

7. A signature device that requests a verification device, which provides a service, to provide a service, comprising:
unit that requests the verification device to provide a service;
unit that requests a certification authority device to send validity check information on an electronic certificate required for verifying a digital signature when the digital signature is attached to an electronic document to be sent to the verification device in order to receive the service;
unit that puts the digital signature, whose validity can be checked by the validity check information sent from the certification authority device, on the electronic document; and
unit that sends the signed data, the electronic certificate, and the validity check information to the verification device.

8. The signature device according to claim 7, wherein
the request for requesting the certification authority device to provide the validity check information is issued in response to the request for providing the validity check information that is issued in response to the request for requesting the verification device to provide a service.

9. For use in a system comprising a signature device that requests to provide a service and a verification device that provides a requested service, a certification authority device that provides validity check information on an electronic certificate to be sent from the signature device to the verification device, the certification authority device comprising:
unit that accepts from the signature device a request to provide the validity check information; and
unit that provides the requested validity check information to the signature device.

10. The certification authority device according to claim 9, further comprising:
unit that sets a term of validity for the validity check information to be provided.

11. The certification authority device according to claim 9, further comprising:
unit that counts a number of times each signature device, which requests to provide the validity check information, requests to provide the validity check information; and
unit that performs charging processing for the signature device according to the number of times that is counted.
